(19) United States
(12) Patent Application Publication
(10) Pub. No.: US 2026/0118648 A1
(43) Pub. Date: Apr. 30, 2026

(54) ZOOM LENS AND IMAGE PICKUP APPARATUS

(71) Applicant: CANON KABUSHIKI KAISHA, Tokyo (JP)

(72) Inventors: Yonghee LEE, Saitama (JP); Masatsugu NAKANO, Tochigi (JP)

(21) Appl. No.: 19/320,120

(22) Filed: Sep. 5, 2025

(30) Foreign Application Priority Data
Oct. 30, 2024 (JP) 2024-191079

(51) Int. Cl. G02B 15/14; G02B 15/16

(52) U.S. Cl. CPC G02B 15/145125; G02B 15/145117; G02B 15/16

(57) ABSTRACT

Zoom lenses and image pickup apparatuses are provided herein. One or more zoom lenses may include a plurality of lens units, which include, in order from an object side to an image side, a first lens unit with positive refractive power that does not move for zooming, an intermediate group including at least three movable lens units that move for zooming, and a rear lens unit with positive refractive power that does not move for zooming. Each distance between adjacent lens units changes during zooming. The first lens unit includes a focus sub-lens unit that moves for focusing. One of the at least three movable lens units in the intermediate group includes an aperture stop. A predetermined inequality is satisfied.

### BACKGROUND

### Field of the Technology

The aspect of the disclosure relates to one or more embodiments of a zoom lens for imaging.

### Description of the Related Art

A zoom lens is demanded to have a reduced size, a wide angle of view, and high optical performance. Japanese Patent Application Laid-Open No. 2019-090906 discloses a zoom lens that includes, in order from the object side to the image side, a first lens unit with positive refractive power that does not move for zooming, a plurality of movable lens units that move for zooming, and a rear lens unit with positive refractive power that does not move for zooming. The first lens unit in this zoom lens includes a focus lens unit that moves for focusing.

### SUMMARY

One or more embodiments of a zoom lens according to one or more aspects of the disclosure may include a plurality of lens units, which include, in order from an object side to an image side, a first lens unit with positive refractive power that does not move for zooming, an intermediate group including at least three movable lens units that move for zooming, and a rear lens unit with positive refractive power that does not move for zooming. Each distance between adjacent lens units changes during zooming. The first lens unit includes a focus sub-lens unit that moves for focusing. One of the at least three movable lens units in the intermediate group includes an aperture stop. The following inequalities are satisfied:

$$12 \leq LS / fw \leq 40$$

$$- 0.1 \; 5 \leq fw / LP \leq - 0.01$$

where LS is a distance on an optical axis from the aperture stop to an image plane at a wide-angle end, fw is a focal length of the zoom lens at the wide-angle end, LP is a distance on the optical axis from the image plane to an exit pupil of the zoom lens at the wide-angle end, and a direction from the image plane toward the object side is negative. Alternatively, the following inequality is satisfied:

$$12 \leq LS / fw \leq 40$$

where LS is a distance on an optical axis from the aperture stop to an image plane at a wide-angle end, fw is a focal length of the zoom lens at the wide-angle end. One or more image pickup apparatuses may include one or more zoom lenses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1.

FIGS. 2A and 2B are aberration diagrams of the zoom lens according to Example 1 at a wide-angle end and a telephoto end, respectively.

FIG. 3 is a sectional view of a zoom lens according to Example 2.

FIGS. 4A and 4B are aberration diagrams of the zoom lens according to Example 2 at a wide-angle end and a telephoto end, respectively.

FIG. 5 is a sectional view of a zoom lens according to Example 3.

FIGS. 6A and 6B are aberration diagrams of the zoom lens according to Example 3 at a wide-angle end and a telephoto end, respectively.

FIG. 7 is a sectional view of a zoom lens according to Example 4.

FIGS. 8A and 8B are aberration diagrams of the zoom lens according to Example 4 at a wide-angle end and a telephoto end, respectively.

FIG. 9 is a sectional view of a zoom lens according to Example 5.

FIGS. 10A and 10B are aberration diagrams of the zoom lens according to Example 5 at a wide-angle end and a telephoto end, respectively.

FIG. 11 is a sectional view of a zoom lens according to Example 6.

FIGS. 12A and 12B are aberration diagrams of the zoom lens according to Example 6 at a wide-angle end and a telephoto end, respectively.

FIG. 13 illustrates an image pickup apparatus using any one of the zoom lenses according to Examples 1 to 6.

### DESCRIPTION OF THE EMBODIMENTS

A description will be given of examples according to the disclosure with reference to the drawings. First, before Examples 1 to 6 are described, matters common to each example will be described.

A zoom lens according to each example is used for a variety of image pickup apparatuses such as cinema cameras, broadcasting cameras, video cameras, surveillance cameras, digital still cameras, and film-based cameras. In a zoom lens, a lens unit is a group of one or more lenses that may or may not move as a unit during magnification variation (zooming) between the wide-angle end and the telephoto end. In other words, each distance between adjacent lens units changes during zooming. The lens unit may include an aperture stop (diaphragm). The wide-angle end and the telephoto end respectively indicate zoom states of the maximum angle of view (shortest focal length) and the minimum angle of view (longest focal length) when the lens unit that moves during zooming is located at both ends of the mechanically or controllably movable range on the optical axis.

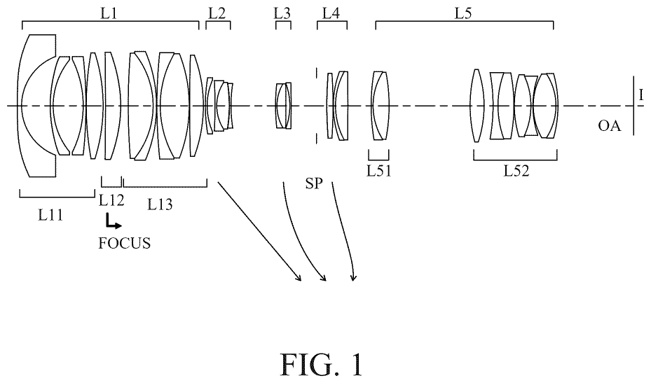

FIGS. 1, 3, 5, 7, 9, and 11 respectively illustrate cross sections of zoom lenses according to Examples 1 to 6 in an in-focus state on an object at infinity (referred to as “in an in-focus state at infinity” hereinafter) at the wide-angle end. In each figure, a left side is an object side (front side) and a right side is an image side (rear side). OA indicates an optical axis of the zoom lens. Li is an i-th (i=1, 2, 3, . . . ) lens unit counted from the object side, and L1m is an m-th (m=1, 2, 3, . . . ) sub-lens unit counted from the object side in the first lens unit L1. A sub-lens unit is a group of one or more lenses that move or do not move integrally during focusing. Ln or L6n is an n-th (n=1, 2) sub-lens unit counted from the object side in the rear lens unit (L5 or L6), and these sub-lens units are arranged via the widest distance in the rear lens unit.

SP is an aperture stop (diaphragm), and I is an image plane. An imaging surface (light receiving surface) of the image sensor in the image pickup apparatus and a film surface (photosensitive surface) of the silver film are located on the image plane I. An arrow is attached below the lens unit that moves during zooming to illustrate a moving locus (trajectory) of that lens unit during zooming from the wide-angle end to the telephoto end. An arrow labeled FOCUS is attached below the lens unit (sub-lens unit) that moves during focusing to illustrate a moving direction of that lens unit during focusing from infinity to a close distance.

The zoom lens according to each example includes, in order from the object side to the image side, a plurality of lens units, which include a first lens unit with positive refractive power that does not move for zooming, an intermediate group including at least three movable lens units that move for zooming, and a rear lens unit with positive refractive power that does not move for zooming. The first lens unit includes a focus sub-lens unit that moves for focusing. One of the movable lens units in the intermediate group includes an aperture stop.

The following inequalities (1) and (2) may be satisfied:

$$12 \leq LS / fw \leq 40 \qquad ( 1 )$$

$$- 0.15 \leq fw / LP \leq - 0.01 \qquad ( 2 )$$

where LS is a distance on the optical axis from the aperture stop to the image plane I at the wide-angle end, fw is a focal length of the zoom lens at the wide-angle end, LP is a distance on the optical axis from the exit pupil of the zoom lens at the wide-angle end to the image plane, and the distance LP is negative in a direction from the image plane toward the object side.

Inequality (1) defines a proper relationship between the distance from the aperture stop to the image plane I at the wide-angle end and the focal length of the zoom lens to achieve a wide angle of view and a reduced size. In a case where LS/fw becomes higher than the upper limit of inequality (1), the distance LS becomes too long compared to the focal length fw, and the incident angle of the light beam on the image plane I reduces. The most off-axis light determines the diameter of the lens placed closest to the image plane. In this case, in a case where the distance LS increases, the diameter of the lens and thus the size of the zoom lens increase, and it becomes difficult to achieve a wide angle. In a case where LS/fw becomes lower than the lower limit of inequality (1), the distance from the lens closest to the object to the aperture stop and thus the lens diameter increase, and it becomes difficult to achieve both a wide angle and a reduced size.

The upper limit of inequality (1) may be set to 35, 30, 25, 20, or 16. The lower limit of inequality (1) may be set to 12.5, 13, 13.5, or 14.

Inequality (2) defines a proper relationship between the distance from the exit pupil to the image plane I at the wide-angle end and the focal length of the zoom lens in order to make the light ray incident on the image plane I at a proper incident angle. In general, the sensitivity characteristic of the image sensor disposed on the image plane I decreases as the incident angle of the light ray increases. Thus, a proper incident angle of the light ray on the image plane I may be obtained in order to achieve good optical performance. In a case where fw/LP becomes higher than the upper limit of inequality (2), the exit pupil is located behind the image plane I, and a light ray emitted from the lens closest to the image plane enters the image plane I obliquely relative to the optical axis direction. As a result, the diameter of the lens closest to the image plane increases, and it becomes difficult to attach the zoom lens to a camera. In a case where fw/LP becomes lower than the lower limit of inequality (2), the exit pupil becomes too close to the image plane I, and the incident angle of the light ray emitted from the lens closest to the image plane I increases.

The upper limit of inequality (2) may be set to −0.02 or −0.03. The lower limit of inequality (2) may be set to −0.12, −0.10, or −0.08.

The above configuration and satisfying at least one of inequalities (1) and (2) can achieve a zoom lens that has a reduced size and a wide angle of view, and can make a light ray incident on the image plane (image sensor) I at a proper incident angle.

The zoom lens according to each example may satisfy at least one of inequalities (3) to (8) below:

$$0.35 \leq LE / LR \leq 0.6 \qquad ( 3 )$$

$$0.9 \leq fRR / fR \leq 2.4 \qquad ( 4 )$$

$$1. \leq fFR / fR \leq 3.4 \qquad ( 5 )$$

$$1.7 \leq NR \leq 2. \qquad ( 6 )$$

$$1. \leq f 1 / fw \leq 10. \qquad ( 7 )$$

$$- 6. \leq f 1 / f 2 < 0. \qquad ( 8 )$$

The rear lens unit may include a front sub-lens unit and a rear sub-lens unit arranged in this order from the object side to the image side via the widest distance in the rear lens unit. In inequality (3), LE is the widest distance, and LR is a distance on the optical axis from a surface closest to the object of the rear lens unit to a surface closest to the image plane of the rear lens unit. In inequalities (4) to (8), fR is a focal length of the rear lens unit, fRR is a focal length of the rear sub-lens unit, and fFR is a focal length of the front sub-lens unit. NR is an average value of a refractive index for the d-line of all lenses included in the rear sub-lens unit. f1 is a focal length of the first lens unit L1. The intermediate group includes one or two lens units and has a variator unit with negative refractive power as a whole, and f2 is a focal length of the variator unit.

Inequality (3) defines a proper relationship between the overall length of the rear lens unit, which allows the insertion and removal of an optical unit such as an extender for focal length conversion, and a length of the space (distance) between the front sub-lens unit and the rear sub-lens unit. In a case where LE/LR becomes higher than the upper limit of inequality (3), the above distance and thus the size of zoom lens increase. In a case where LE/LR becomes lower than the lower limit of inequality (3), sufficient space cannot be secured in the rear lens unit to insert an optical unit.

The upper limit of inequality (3) may be set to 0.55, 0.50, or 0.45. The lower limit of inequality (3) may be set to 0.37, 0.38, or 0.39.

Inequality (4) defines a proper relationship between the focal lengths of the rear sub-lens unit and the rear lens unit. In a case where fRR/fR becomes higher than the upper limit of inequality (4), the power of the rear sub-lens unit reduces, the back focus and thus the size of the zoom lens increase. In a case where fRR/fR becomes lower than the lower limit of inequality (4), the power of the rear sub-lens unit increases and it becomes difficult to properly set the position of the exit pupil.

The upper limit of inequality (4) may be set to 2.2, 2.1, or 2.0. The lower limit of inequality (4) may be set to 1.0, 1.1, 1.2, or 1.3.

Inequality (5) defines a proper relationship between the focal lengths of the front sub-lens unit and the rear lens unit. In a case where fFR/fR becomes higher than the upper limit of inequality (5), the power of the rear lens unit increases and it becomes difficult to correct a variety of aberrations. In a case where fFR/fR becomes lower than the lower limit of inequality (5), the power of the front sub-lens unit increases and aberrational fluctuations between an insertion state of an optical unit between the front sub-lens unit and the rear sub-lens unit and a removal state of the optical unit become significant.

The upper limit of inequality (5) may be set to 3.2, 3.1, or 3.0. The lower limit of inequality (5) may be set to 1.2, 1.4, 1.6, or 1.7.

Inequality (6) defines a proper refractive index for the d-line of the lens (glass material) that is used for the rear lens unit. In a case where NR becomes higher than the upper limit of inequality (6), it becomes difficult to correct chromatic aberration because a dispersion difference cannot be generated between the positive lens and the negative lens. In a case where NR becomes lower than the lower limit of inequality (6), the refractive index reduces and it becomes difficult to keep the aberration within the permissible range.

The upper limit of inequality (6) may be set to 1.980, 1.960, 1.940, 1.900, or 1.850. The lower limit of inequality (6) may be set to 1.720, 1.740, 1.760, or 1.780.

Inequality (7) defines a proper relationship between the focal lengths of the first lens unit L1 and the variator unit to achieve a zoom lens that has a reduced size, a wide angle of view, a high magnification variation ratio, and high optical performance. In a case where f1/fw becomes higher than the upper limit of inequality (7), the diameter of the first lens unit L1 and thus the size of the zoom lens increase. In a case where f1/fw becomes lower than the lower limit of inequality (7), it becomes difficult to achieve a zoom lens with a wide angle of view and a high magnification variation ratio, or it becomes difficult to suppress aberrations at the wide-angle end within a permissible range.

The upper limit of inequality (7) may be set to 9.00, 8.00, 5.00, 3.00, or 2.50. The lower limit of inequality (7) may be set to 1.50, 1.80, 2.00, or 2.20.

Inequality (8) defines a proper relationship between the focal lengths of the first lens unit and the variator unit in the intermediate group. In a case where f1/f2 satisfies inequality (8), a refractive power arrangement that is beneficial to a reduced size and weight, and high magnification of the zoom lens. In a case where f1/f2 becomes higher than the upper limit of inequality (8), the power of the variator becomes too weak relative to the power of the first lens unit L1, and it becomes difficult to achieve high magnification. In a case where f1/f2 becomes lower than the lower limit of inequality (8), the power of the variator unit increases, and the aberration fluctuation during zooming increases or it becomes difficult to achieve a zoom lens that has a reduced size and weight in an attempt to suppress the aberration fluctuation.

The upper limit of inequality (8) may be set to −0.03, −0.06, −0.10, −0.50, −0.70, or −0.80. The lower limit of inequality (8) may be set to −5.00, −4.00, −3.00, −2.00 or −1.00.

The zoom lens according to each example may have at least one of the following configurations.

The lens closest to the image plane of the rear sub-lens unit may have negative refractive power. Due to this configuration, the principal point position of the rear lens unit can be moved toward the object side, and it becomes easy to make a light ray incident on the image plane I at a proper incident angle.

The rear sub-lens unit may include seven or more lenses. A cemented lens in which two lenses are cemented together is counted as two lenses. This configuration can provide good aberration correction, and achieve high optical performance.

The zoom lens according to each example will be specifically described below. After Example 6, numerical examples 1 to 6 corresponding to Examples 1 to 6 will be illustrated, respectively.

### Example 1

A zoom lens according to Example 1 (numerical example 1) illustrated in FIG. 1 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 are the movable lens units that move for zooming, and constitute the intermediate group. The fifth lens unit L5 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power.

The second lens unit L2 is a variator unit with negative refractive power, and moves toward the image side during zooming from the wide-angle end to the telephoto end. Each of the third lens unit L3 and the fourth lens unit L4 moves toward the image side during zooming from the wide-angle end to the telephoto end. The aperture stop SP also moves integrally with the fourth lens unit L4.

The fifth lens unit L5 includes a front sub-lens unit L51 and a rear sub-lens unit L52 arranged in this order from the object side to the image side, and has a total of nine lenses. The fifth lens unit L5 may include seven or eight lenses. The front sub-lens unit L51 includes a cemented lens of a negative lens and a positive lens, and the rear sub-lens unit L52 includes a positive lens, a cemented lens of a negative lens and a positive lens, a cemented lens of a positive lens and a negative lens, and a cemented lens of a positive lens and a negative lens. An optical unit such as an extender lens may be inserted into the space between the front sub-lens unit L51 and the rear sub-lens unit L52.

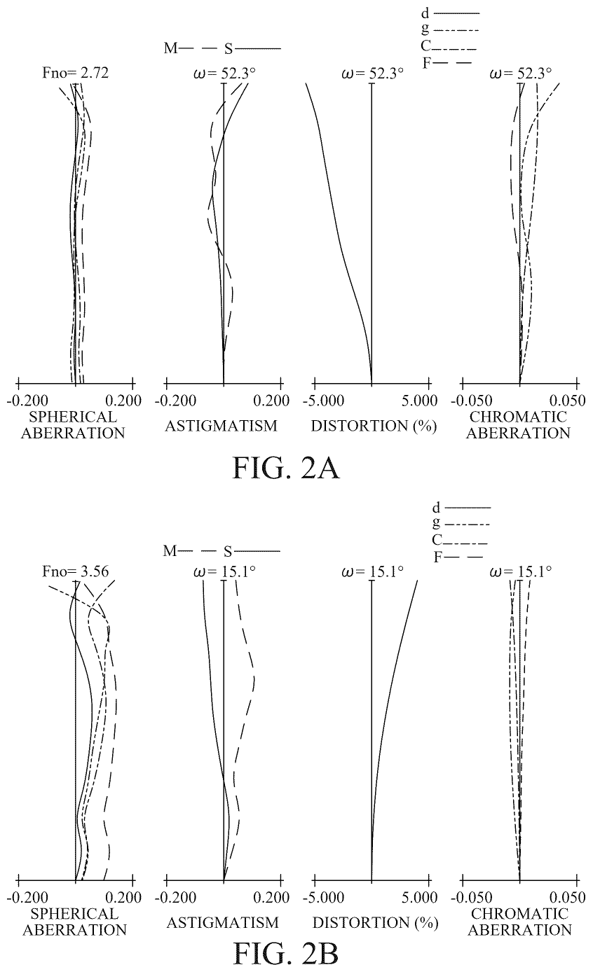

FIG. 2A illustrates longitudinal aberrations (spherical aberration, astigmatism, distortion, and chromatic aberration) of the zoom lens according to numerical example 1 in an in-focus state at infinity at a wide-angle end. FIG. 2B illustrates longitudinal aberration of the zoom lens according to numerical example 1 in the in-focus state at infinity at a telephoto end.

In the spherical aberration diagram, Fno indicates the F-number. A solid line indicates a spherical aberration amount for the d-line (wavelength 587.6 nm), and an alternate long and two short dashes line indicates a spherical aberration amount for the g-line (wavelength 435.8 nm). An alternate long and short dash line indicates a spherical aberration amount for the C-line (wavelength 656.3 nm), and a broken line indicates a spherical aberration amount for the F-line (wavelength 486.1 nm). In the astigmatism diagram, a solid line S indicates an astigmatism amount on a sagittal image plane, and a broken line M indicates an astigmatism amount on a meridional image plane. The distortion diagram illustrates a distortion amount for the d-line. The chromatic aberration diagram illustrates lateral chromatic aberration amounts for the g-line, C-line, and F-line. The astigmatism diagram and chromatic aberration diagram illustrate aberration amounts in a case where a central ray of a light beam at the aperture position is a principal ray. @ is a paraxial half angle of view) (°. The spherical aberration is drawn on a scale of 0.2 mm, the astigmatism is drawn on a scale of 0.2 mm, the distortion is drawn on a scale of 5%, and the chromatic aberration is drawn on a scale of 0.05 mm. The above description of the aberration diagrams also applies to the aberration diagrams of other numerical examples.

### Example 2

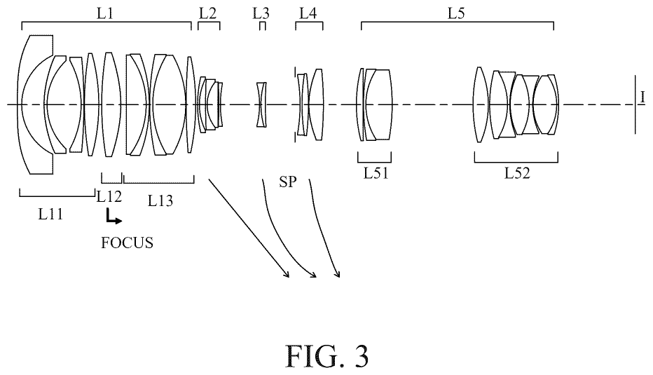

A zoom lens according to Example 2 (numerical example 2) illustrated in FIG. 3 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 are the movable lens units that move for zooming, and constitute the intermediate group. The fifth lens unit L5 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit with negative refractive power, and moves toward the image side during zooming from the wide-angle end to the telephoto end. Each of the third lens unit L3 and the fourth lens unit L4 moves toward the image side during zooming from the wide-angle end to the telephoto end. The aperture stop SP also moves integrally with the fourth lens unit L4.

The fifth lens unit L5 includes a front sub-lens unit L51 and a rear sub-lens unit L52 arranged in this order from the object side to the image side, and has a total of ten lenses. The front sub-lens unit L51 includes a positive lens, a cemented lens of a negative lens and a positive lens, and the rear sub-lens unit L52 includes a positive lens, a cemented lens of a positive lens and a negative lens, a cemented lens of a positive lens and a negative lens, and a cemented lens of a positive lens and a negative lens. An optical unit such as an extender may be inserted into the space between the front sub-lens unit L51 and the rear sub-lens unit L52.

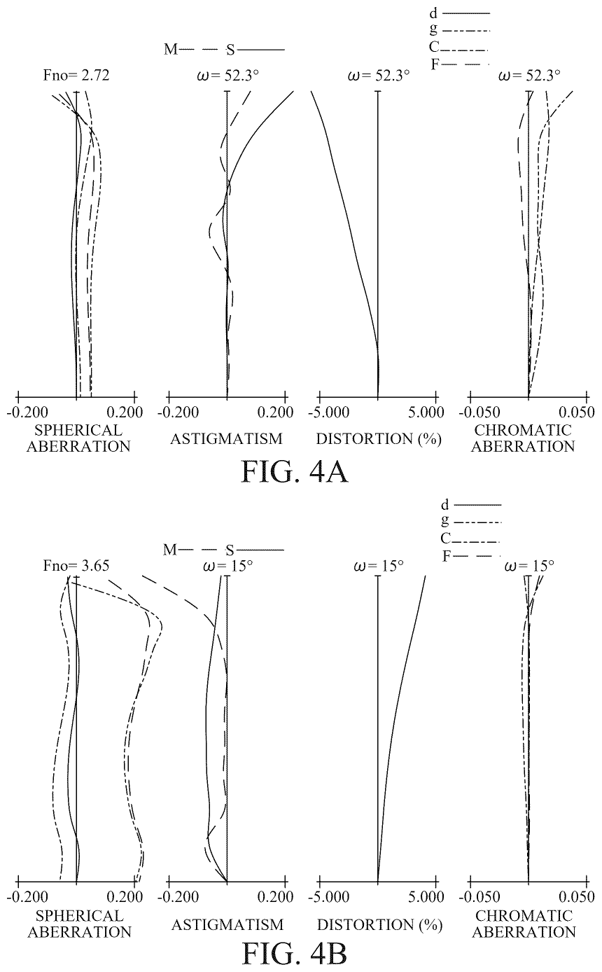

FIG. 4A illustrates longitudinal aberrations of the zoom lens according to numerical example 2 in an in-focus state at infinity at a wide-angle end. FIG. 4B illustrates longitudinal aberration of the zoom lens according to numerical example 2 in the in-focus state at infinity at a telephoto end.

### Example 3

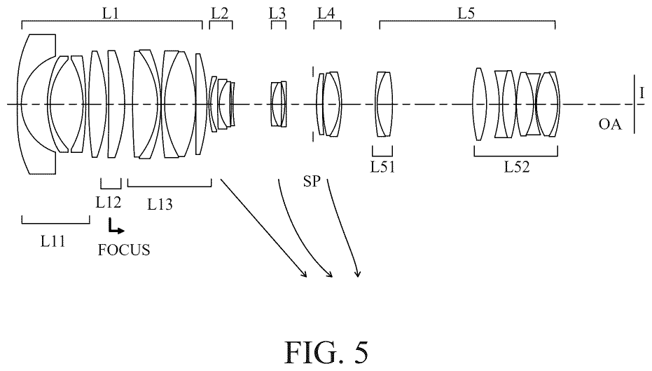

A zoom lens according to Example 3 (numerical example 3) illustrated in FIG. 5 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 are the movable lens units that move for zooming, and constitute the intermediate group. The fifth lens unit L5 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit with negative refractive power, and moves toward the image side during zooming from the wide-angle end to the telephoto end. Each of the third lens unit L3 and the fourth lens unit L4 moves toward the image side during zooming from the wide-angle end to the telephoto end. The aperture stop SP also moves integrally with the fourth lens unit L4.

The fifth lens unit L5 includes a front sub-lens unit L51 and a rear sub-lens unit L52 arranged in this order from the object side to the image side, and has a total of nine lenses. The front sub-lens unit L51 includes a cemented negative lens and a positive lens, and the rear sub-lens unit L52 includes a positive lens, a cemented lens of a negative lens and a positive lens, a cemented lens of a positive lens and a negative lens, and a cemented lens of a positive lens and a negative lens. An optical unit such as an extender may be inserted into the space between the front sub-lens unit L51 and the rear sub-lens unit L52.

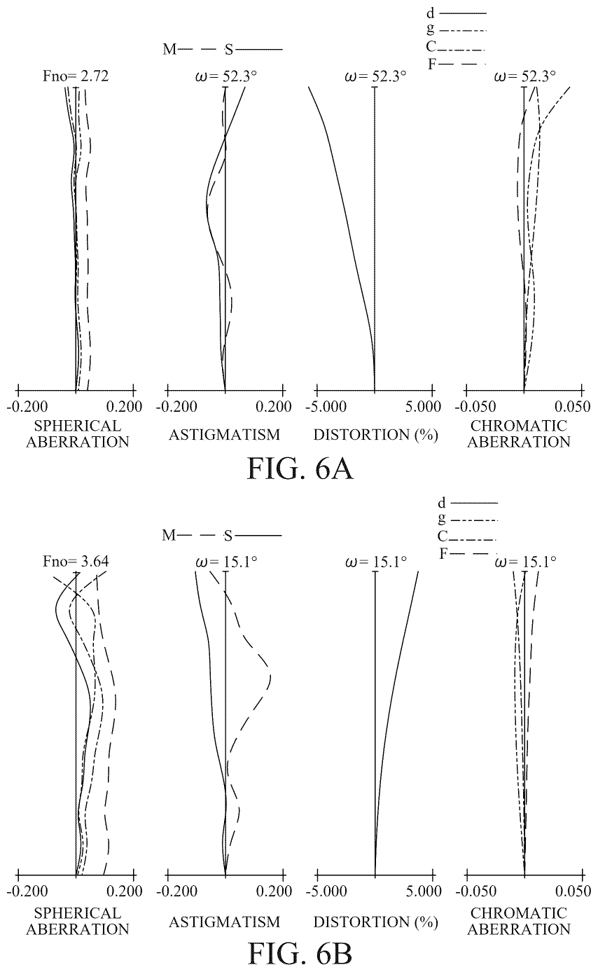

FIG. 6A illustrates longitudinal aberrations of the zoom lens according to numerical example 3 in an in-focus state at infinity at a wide-angle end. FIG. 6B illustrates longitudinal aberrations of the zoom lens according to numerical example 3 in the in-focus state at infinity at a telephoto end.

### Example 4

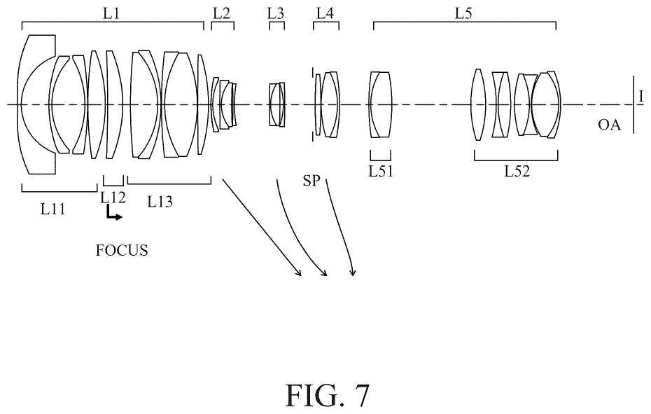

A zoom lens according to Example 4 (numerical example 4) illustrated in FIG. 7 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 are the movable lens units that move for zooming, and constitute an intermediate group. The fifth lens unit L5 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side when focusing from infinity to a close distance.

The second lens unit L2 is a variator unit with negative refractive power, and moves toward the image side during zooming from the wide-angle end to the telephoto end. Each of the third lens unit L3 and the fourth lens unit L4 moves toward the image side during zooming from the wide-angle end to the telephoto end. The aperture stop SP also moves integrally with the fourth lens unit L4.

The fifth lens unit L5 includes a front sub-lens unit L51 and a rear sub-lens unit L52 arranged in this order from the object side to the image side, and has a total of nine lenses. The front sub-lens unit L51 includes a cemented lens of a negative lens and a positive lens, and the rear sub-lens unit L52 includes a positive lens, a cemented lens of a negative lens and a positive lens, a cemented lens of a positive lens and a negative lens, and a cemented lens of a positive lens and a negative lens. An optical unit such as an extender may be inserted into the space between the front sub-lens unit L51 and the rear sub-lens unit L52.

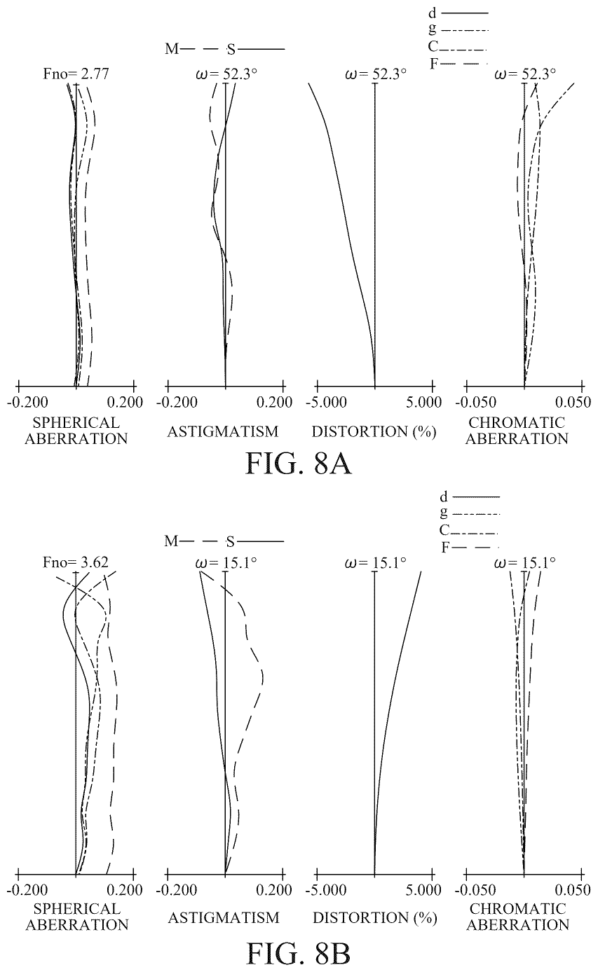

FIG. 8A illustrates longitudinal aberrations of the zoom lens according to numerical example 4 in an in-focus state at infinity at a wide-angle end. FIG. 8B illustrates longitudinal aberrations of the zoom lens according to numerical example 4 in the in-focus state at infinity at a telephoto end.

### Example 5

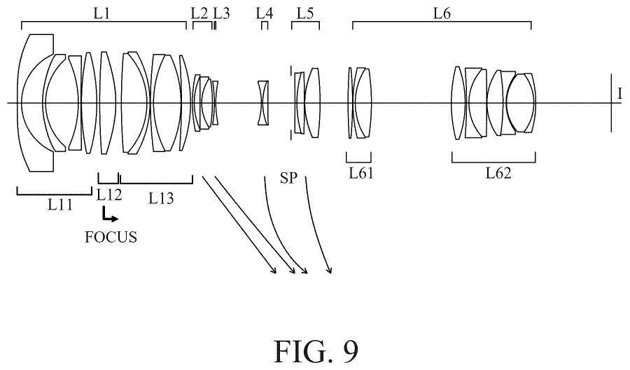

A zoom lens according to Example 5 (numerical example 5) illustrated in FIG. 9 includes, in order from the object side to the image side, a first lens unit L1 with positive refractive power, a second lens unit L2 with negative refractive power, a third lens unit L3 with negative refractive power, a fourth lens unit L4 with negative refractive power, a fifth lens unit L5 with positive refractive power including an aperture stop SP, and a sixth lens unit L6 with positive refractive power. The first lens unit L1 does not move for zooming. The second lens unit L2, the third lens unit L3, the fourth lens unit L4, and the fifth lens unit L5 are the movable lens units that move for zooming, and constitute the intermediate group. The sixth lens unit L6 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 and the third lens unit L3 together form a variator unit with negative refractive power and configured to move toward the image side during zooming from the wide-angle end to the telephoto end. Each of the fourth lens unit L4 and the fifth lens unit L5 moves toward the image side during zooming from the wide-angle end to the telephoto end. The aperture stop SP also moves integrally with the fifth lens unit L5.

The sixth lens unit L6 includes a front sub-lens unit L61 and a rear sub-lens unit L62 arranged in this order from the object side to the image side, and has a total of ten lenses. The front sub-lens unit L61 includes a positive lens and a cemented lens of a negative lens and a positive lens, and the rear sub-lens unit L62 includes a positive lens, a cemented lens of a negative lens and a positive lens, a cemented lens of a positive lens and a negative lens, and a cemented lens of a positive lens and a negative lens. An optical unit such as an extender may be inserted into the space between the front sub-lens unit L61 and the rear sub-lens unit L62.

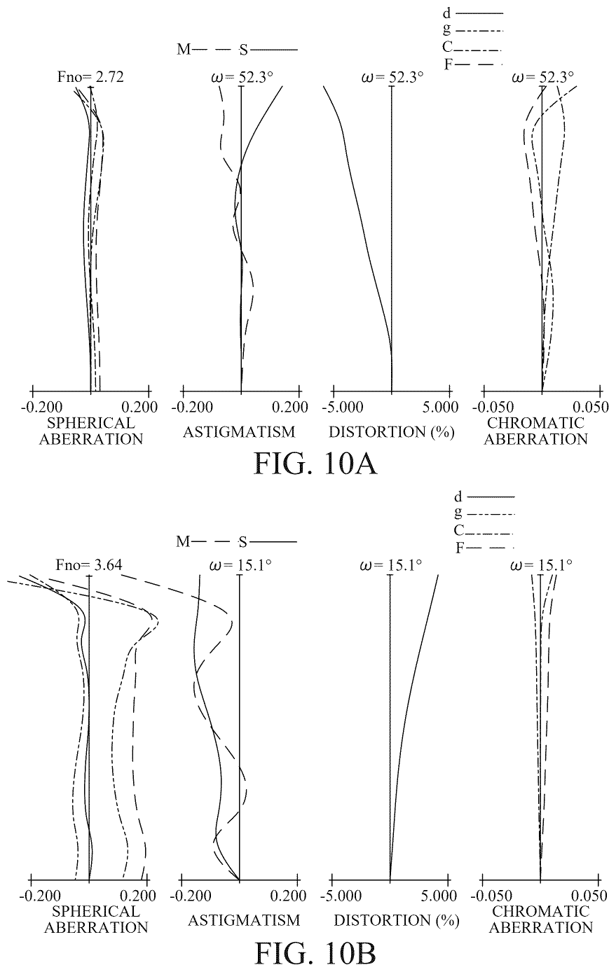

FIG. 10A illustrates longitudinal aberrations of the zoom lens according to numerical example 5 in an in-focus state at infinity at a wide-angle end. FIG. 10B illustrates longitudinal aberrations of the zoom lens according to numerical example 5 in the in-focus state at infinity at a telephoto end.

### Example 6

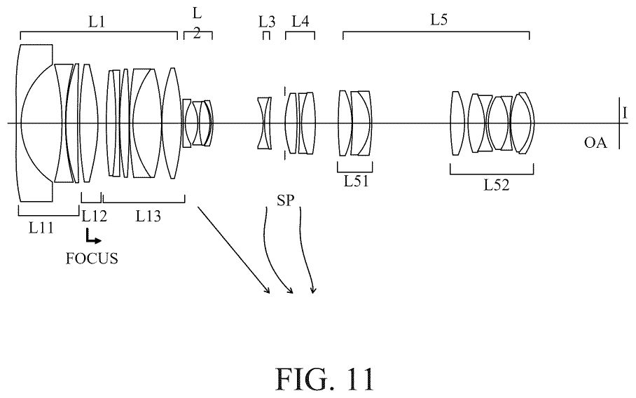

A zoom lens according to Example 6 (numerical example 6) illustrated in FIG. 11 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 are the movable lens units that move for zooming and constitute the intermediate group. The fifth lens unit L5 is the rear lens unit for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit with negative refractive power, and moves toward the image side during zooming from the wide-angle end to the telephoto end. Each of the third lens unit L3 and the fourth lens unit L4 moves toward the image side during zooming from the wide-angle end to the telephoto end. The aperture stop SP also moves integrally with the fourth lens unit L4.

The fifth lens unit L5 includes a front sub-lens unit L51 and a rear sub-lens unit L52 arranged in this order from the object side to the image side, and has a total of ten lenses. The front sub-lens unit L61 includes a positive lens and a cemented lens of a positive lens and a negative lens, and the rear sub-lens unit L62 includes a positive lens, a cemented lens of a positive lens and a negative lens, a cemented lens of a positive lens and a negative lens, and a cemented lens of a positive lens and a negative lens. An optical unit such as an extender may be inserted into the space between the front sub-lens unit L61 and the rear sub-lens unit L62.

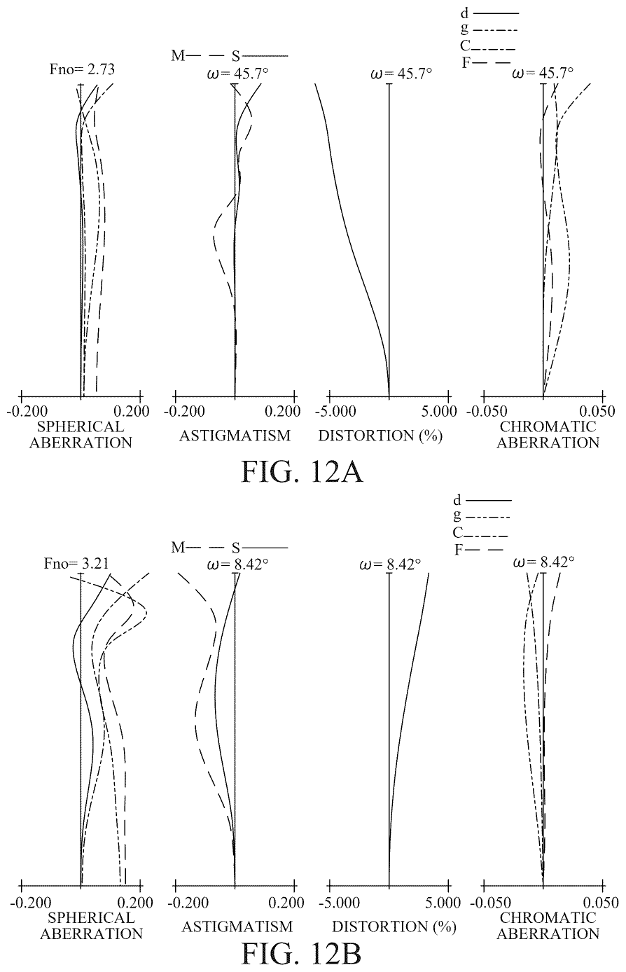

FIG. 12A illustrates longitudinal aberration of the zoom lens according to numerical example 6 in an in-focus state at infinity at a wide-angle end. FIG. 12B illustrates longitudinal aberration of the zoom lens according to numerical example 6 in the in-focus state at infinity at a telephoto end.

Numerical examples 1 to 6 will be illustrated below. In each numerical example, surface number i represents the order of the surface from the object side, r represents a radius of curvature (mm) of an i-th surface, and d represents a distance (mm) on the optical axis between i-th and (i+1)-th surfaces. (variable) of the distance d indicates a distance that changes during zooming, and a distance according to the focal length is illustrated in a separate table. nd represents an absolute refractive index at 1 atmospheric pressure for the d-line of an optical material between i-th and (i+1)-th surfaces. vd is an Abbe number of an optical material between i-th and (i+1)-th surfaces based on the d-line. The Abbe number vd based on the d-line is expressed as:

$$vd = ( Nd - 1 ) / ( NF - NC )$$

where Nd, NF, and NC are refractive indices for the d-line, F-line, and C-line, respectively.

θgF is a partial dispersion ratio of an optical material between i-th and (i+1)-th surfaces to the g-line and F-line.

The partial dispersion ratio of the g-line and F-line is expressed as:

$$θ gF = ( Ng - NF ) / ( NF - NC )$$

where Ng is a refractive index for the g-line.

Each numerical example also illustrates a half angle of view) (°) of the zoom lens, in addition to the focal length, F-number, and other specifications of the zoom lens. BF is the back focus, which indicates the air-equivalent distance on the optical axis from the lens surface (last surface) closest to the image plane of the zoom lens to the image surface. The overall lens length is a distance on the optical axis from the lens surface closest to the object (the frontmost surface) of a zoom lens to the final surface plus the back focus. The lens unit data indicates the focal length of each lens unit.

An asterisk “*” next to a surface number means that the surface has an aspheric shape. An aspheric shape is expressed by the following equation:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 3 \cdot {H}^{3} + A 5 \cdot {H}^{5} + A 7 \cdot {H}^{7} + A 9 \cdot {H}^{9} + A 11 \cdot {H}^{11} + A 13 \cdot {H}^{13} + A 15 \cdot {H}^{15}$$

where X is a displacement amount from a surface vertex in the optical axis direction, H is a height from the optical axis in a direction orthogonal to the optical axis, a light traveling direction is positive, R is a paraxial radius of curvature, k (K in each numerical example) is a conic constant, and A3 to A16 are aspheric coefficients.

The “e±x” in the conic constant and aspheric coefficients means ×10^{±x}. WIDE represents a wide-angle end, MIDDLE represents an intermediate zoom position, and TELE represents a telephoto end.

### Numerical Example 1

UNIT: mm
SURFACE DATA

| Surface No. | r | d | nd | νd | θgF |
|---|---|---|---|---|---|
| 1* | 99476.214 | 2.10 | 1.83481 | 42.7 | 0.5648 |
| 2 | 26.526 | 14.50 | | | |
| 3* | 60.656 | 1.50 | 1.80400 | 46.5 | 0.5577 |
| 4 | 36.393 | 15.23 | | | |
| 5 | −52.015 | 1.40 | 1.91650 | 31.6 | 0.5911 |
| 6 | −221.790 | 0.15 | | | |
| 7 | 148.608 | 8.53 | 1.80810 | 22.8 | 0.6307 |
| 8 | −87.769 | 1.20 | | | |
| 9 | −1825.418 | 7.71 | 1.59522 | 67.7 | 0.5442 |
| 10* | −66.130 | 3.82 | | | |
| 11 | 330.801 | 12.62 | 1.49700 | 81.5 | 0.5375 |
| 12 | −41.914 | 1.70 | 1.95375 | 32.3 | 0.5905 |
| 13 | −69.223 | 0.20 | | | |
| 14 | 250.952 | 1.70 | 2.00100 | 29.1 | 0.5997 |
| 15 | 52.142 | 14.71 | 1.53775 | 74.7 | 0.5392 |
| 16 | −71.364 | 0.20 | | | |
| 17 | 903.164 | 6.96 | 1.65412 | 39.7 | 0.5737 |
| 18 | −72.430 | (Variable) | | | |
| 19 | 84.669 | 0.93 | 1.85150 | 40.8 | 0.5695 |
| 20 | 32.767 | 3.97 | | | |
| 21 | −229.954 | 0.85 | 1.76385 | 48.5 | 0.5589 |
| 22 | 21.414 | 6.33 | 1.85478 | 24.8 | 0.6122 |
| 23 | −75.689 | 0.15 | | | |
| 24 | −70.958 | 0.75 | 2.00100 | 29.1 | 0.5997 |
| 25 | 69.265 | (Variable) | | | |
| 26 | 107.428 | 0.70 | 1.83481 | 42.7 | 0.5648 |
| 27 | 21.997 | 4.53 | 1.78880 | 28.4 | 0.6009 |
| 28 | −1529.445 | 1.99 | | | |
| 29 | −32.371 | 0.70 | 1.90525 | 35.0 | 0.5848 |
| 30 | −367.030 | (Variable) | | | |
| 31 (SP) | ∞ | 5.25 | | | |
| 32* | 156.160 | 3.17 | 1.51633 | 64.1 | 0.5353 |
| 33 | −243.291 | 0.15 | | | |
| 34 | 49.145 | 1.10 | 1.89190 | 37.1 | 0.5780 |
| 35 | 35.423 | 6.28 | 1.68893 | 31.1 | 0.6004 |
| 36 | −1097.453 | (Variable) | | | |
| 37 | 99.723 | 1.00 | 1.96300 | 24.1 | 0.6212 |
| 38 | 31.772 | 8.14 | 1.60311 | 60.6 | 0.5415 |
| 39 | −89.135 | 41.03 | | | |
| 40 | 71.446 | 7.08 | 1.53775 | 74.7 | 0.5392 |
| 41 | −57.888 | 4.57 | | | |
| 42 | −92.881 | 2.50 | 2.00100 | 29.1 | 0.5997 |
| 43 | 48.437 | 8.07 | 1.94594 | 18.0 | 0.6546 |
| 44 | −85.330 | 0.20 | | | |
| 45 | 52.351 | 8.39 | 1.49700 | 81.5 | 0.5375 |
| 46 | −35.707 | 1.00 | 2.05090 | 26.9 | 0.6054 |
| 47 | 45.574 | 0.19 | | | |
| 48 | 32.012 | 11.52 | 1.53172 | 48.8 | 0.5631 |
| 49 | −29.284 | 1.00 | 2.00100 | 29.1 | 0.5997 |
| 50 | −60.145 | 38.36 | | | |
| Image Plane | ∞ | | | | |

ASPHERIC DATA
1st Surface
k = 0.00000e+00 A 4 = −2.99616e−06 A 6 = −4.30031e−07 A 8 = −1.39827e−09
A10 = −2.33775e−13 A12 = 2.12083e−16 A14 = −1.50655e−19 A16 = −1.63467e−23
A 3 = 1.54769e−05 A 5 = 3.14838e−06 A 7 = 3.17770e−08 A 9 = 3.38993e−11
A11 = −9.41310e−15 A13 = 2.01907e−18 A15 = 2.56691e−21
3rd Surface
k = 0.00000e+00 A 4 = 7.64711e−06 A 6 = 8.91121e−07 A 8 = 9.97080e−09
A10 = −6.05496e−12 A12 = −6.58184e−14 A14 = 8.33873e−17 A16 = 2.60566e−20
A 3 = −1.33614e−05 A 5 = −4.27804e−06 A 7 = −1.18897e−07 A 9 = −4.13489e−10
A11 = 1.59614e−12 A13 = −9.76086e−18 A15 = −2.57790e−18
10th Surface
k = 1.82623e−01 A 4 = 1.00880e−06 A 6 = −2.39484e−08 A 8 = −5.09044e−11
A10 = 3.02634e−13 A12 = 7.13817e−17 A14 = 8.73615e−20 A16 = 2.64940e−23
A 3 = 7.14913e−07 A 5 = 1.43878e−07 A 7 = 1.91949e−09 A 9 = −3.22022e−12
A11 = −8.95740e−15 A13 = −4.96495e−21 A15 = −2.93804e−21
32nd Surface
k = 1.89717e+00 A 4 = −4.16229e−06 A 6 = −1.65595e−08 A 8 = −1.32731e−11
A 3 = 1.62956e−06 A 5 = 1.81038e−07 A 7 = 7.51656e−10

VARIOUS DATA
ZOOM RATIO 4.81

| | WIDE | MIDDLE | TELE |
|---|---|---|---|
| Focal Length | 11.44 | 28.45 | 55.01 |
| Fno | 2.72 | 2.72 | 3.56 |
| Half Angle of View (°) | 52.30 | 27.49 | 15.06 |
| Image Height | 14.80 | 14.80 | 14.80 |
| Overall Lens Length | 312.24 | 312.24 | 312.24 |
| BF | 38.36 | 38.36 | 38.36 |
| d18 | 0.99 | 30.23 | 42.76 |
| d25 | 22.60 | 3.77 | 2.24 |
| d30 | 12.78 | 11.02 | 1.84 |
| d36 | 11.76 | 3.11 | 1.30 |

LENS UNIT DATA

| Lens Unit | Starting Surface | Focal Length |
|---|---|---|
| 1 | 1 | 27.09 |
| 2 | 19 | −29.26 |
| 3 | 26 | −53.96 |
| 4 | 31 | 54.38 |
| 5 | 37 | 80.80 |

### Numerical Example 2

UNIT: mm
SURFACE DATA

| Surface No. | r | d | nd | νd | θgF |
|---|---|---|---|---|---|
| 1* | 10000.000 | 2.20 | 1.83481 | 42.7 | 0.5648 |
| 2 | 27.749 | 11.42 | | | |
| 3* | 49.085 | 1.55 | 1.85150 | 40.8 | 0.5695 |
| 4 | 30.638 | 17.41 | | | |
| 5 | −46.581 | 1.45 | 1.95375 | 32.3 | 0.5905 |
| 6 | −238.739 | 0.20 | | | |
| 7 | 154.595 | 7.39 | 1.80810 | 22.8 | 0.6307 |
| 8 | −96.603 | 1.48 | | | |
| 9 | 162.699 | 9.76 | 1.59522 | 67.7 | 0.5442 |
| 10* | −64.531 | 2.87 | | | |
| 11 | −12763.368 | 10.08 | 1.43875 | 94.7 | 0.5340 |
| 12 | −42.977 | 1.60 | 1.89190 | 37.1 | 0.5780 |
| 13 | −70.707 | 0.20 | | | |
| 14 | 119.845 | 1.60 | 2.00100 | 29.1 | 0.5997 |
| 15 | 48.583 | 16.84 | 1.43875 | 94.7 | 0.5340 |
| 16 | −50.931 | 0.20 | | | |
| 17 | 294.717 | 4.87 | 1.72342 | 38.0 | 0.5836 |
| 18 | −117.268 | (Variable) | | | |
| 19 | 61.564 | 0.95 | 1.76385 | 48.5 | 0.5589 |
| 20 | 29.525 | 3.12 | | | |
| 21 | 250.336 | 0.85 | 1.76385 | 48.5 | 0.5589 |
| 22 | 18.336 | 5.49 | 1.78880 | 28.4 | 0.6009 |
| 23 | 548.943 | 0.50 | | | |
| 24 | −179.274 | 0.75 | 1.88300 | 40.8 | 0.5667 |
| 25 | 55.379 | (Variable) | | | |
| 26 | −42.695 | 0.70 | 1.80400 | 46.5 | 0.5577 |
| 27 | 38.583 | 2.30 | 1.78880 | 28.4 | 0.6009 |
| 28 | 188.935 | (Variable) | | | |
| 29 (SP) | ∞ | 2.60 | | | |
| 30 | −85.181 | 1.00 | 1.83481 | 42.7 | 0.5648 |
| 31 | 98.953 | 3.28 | 1.67300 | 38.3 | 0.5757 |
| 32 | −122.559 | 0.20 | | | |
| 33* | 38.040 | 7.45 | 1.67270 | 32.1 | 0.5988 |
| 34 | −172.105 | (Variable) | | | |
| 35 | 72.618 | 3.45 | 1.48749 | 70.2 | 0.5300 |
| 36 | 1960.555 | 0.20 | | | |
| 37 | 105.597 | 1.20 | 2.00069 | 25.5 | 0.6136 |
| 38 | 32.311 | 13.45 | 1.51823 | 58.9 | 0.5457 |
| 39 | −98.288 | 41.34 | | | |
| 40 | 77.401 | 7.81 | 1.49700 | 81.5 | 0.5375 |
| 41 | −48.320 | 0.70 | | | |
| 42 | 67.509 | 9.11 | 1.80810 | 22.8 | 0.6307 |
| 43 | −32.241 | 1.20 | 2.00100 | 29.1 | 0.5997 |
| 44 | 42.196 | 0.20 | | | |
| 45 | 34.592 | 9.65 | 1.72151 | 29.2 | 0.6053 |
| 46 | −31.962 | 1.87 | 2.00100 | 29.1 | 0.5997 |
| 47 | 33.561 | 0.20 | | | |
| 48 | 26.154 | 12.04 | 1.49700 | 81.5 | 0.5375 |
| 49 | −25.837 | 1.00 | 2.00100 | 29.1 | 0.5997 |
| 50 | −50.406 | 39.11 | | | |
| Image Plane | ∞ | | | | |

ASPHERIC DATA
1st Surface
k = 0.00000e+00 A 4 = −5.07434e−05 A 6 = −1.24261e−06 A 8 = −3.02769e−09
A10 = −1.32828e−13 A12 = 3.07317e−16 A14 = 5.96297e−20 A16 = 9.48910e−24
A 3 = 1.76927e−04 A 5 = 1.13306e−05 A 7 = 7.97732e−08 A 9 = 5.93685e−11
A11 = −1.79443e−14 A13 = −2.24213e−18 A15 = −1.37391e−21
3rd Surface
k = 0.00000e+00 A 4 = 3.96188e−05 A 6 = 1.34158e−06 A 8 = 1.02871e−08
A10 = 1.72902e−11 A12 = 8.77815e−15 A14 = 2.79450e−17 A16 = 4.01300e−21
A 3 = −1.26898e−04 A 5 = −9.46089e−06 A 7 = −1.36404e−07 A 9 = −5.39291e−10
A11 = −3.05120e−13 A13 = −6.78412e−16 A15 = −5.34500e−19
10th Surface
k = 0.00000e+00 A 4 = 3.57746e−06 A 6 = 9.61541e−09 A 8 = 2.85213e−12
A 3 = −8.05567e−06 A 5 = −1.68298e−07 A 7 = −2.77725e−10
33rd Surface
k = 0.00000e+00 A 4 = −7.04556e−06 A 6 = 2.57992e−09 A 8 = −2.12778e−12

VARIOUS DATA
ZOOM RATIO 4.81

| | WIDE | MIDDLE | TELE |
|---|---|---|---|
| Focal Length | 11.44 | 28.70 | 55.05 |
| Fno | 2.72 | 2.72 | 3.65 |
| Half Angle of View (°) | 52.30 | 27.28 | 15.05 |
| Image Height | 14.80 | 14.80 | 14.80 |
| Overall Lens Length | 315.78 | 315.78 | 315.78 |
| BF | 39.11 | 39.11 | 39.11 |
| d18 | 0.97 | 29.48 | 41.69 |
| d25 | 20.02 | 3.40 | 6.61 |
| d28 | 15.13 | 12.41 | 3.19 |
| d34 | 16.86 | 7.69 | 1.49 |

LENS UNIT DATA

| Lens Unit | Starting Surface | Focal Length |
|---|---|---|
| 1 | 1 | 26.27 |
| 2 | 19 | −30.57 |
| 3 | 26 | −42.49 |
| 4 | 29 | 61.72 |
| 5 | 35 | 74.99 |

### Numerical Example 3

UNIT: mm
SURFACE DATA

| Surface No. | r | d | nd | νd | θgF |
|---|---|---|---|---|---|
| 1* | ∞ | 2.10 | 1.83481 | 42.7 | 0.5648 |
| 2 | 25.722 | 13.33 | | | |
| 3* | 47.838 | 1.50 | 1.80400 | 46.5 | 0.5577 |
| 4 | 32.923 | 16.84 | | | |
| 5 | −46.067 | 1.40 | 1.91650 | 31.6 | 0.5911 |
| 6 | −159.430 | 1.44 | | | |
| 7 | 198.192 | 9.14 | 1.80810 | 22.8 | 0.6307 |
| 8 | −77.040 | 1.20 | | | |
| 9 | −953.703 | 8.14 | 1.59522 | 67.7 | 0.5442 |
| 10* | −68.369 | 4.06 | | | |
| 11 | 368.956 | 12.80 | 1.49700 | 81.5 | 0.5375 |
| 12 | −43.086 | 1.70 | 1.95375 | 32.3 | 0.5905 |
| 13 | −71.080 | 0.20 | | | |
| 14 | 210.051 | 1.70 | 2.00100 | 29.1 | 0.5997 |
| 15 | 52.917 | 15.92 | 1.53775 | 74.7 | 0.5392 |
| 16 | −64.059 | 0.20 | | | |
| 17 | −4613.630 | 5.61 | 1.65412 | 39.7 | 0.5737 |
| 18 | −90.339 | (Variable) | | | |
| 19 | 59.005 | 0.93 | 1.85150 | 40.8 | 0.5695 |
| 20 | 30.082 | 3.53 | | | |
| 21 | 283.197 | 0.85 | 1.76385 | 48.5 | 0.5589 |
| 22 | 18.896 | 5.40 | 1.85478 | 24.8 | 0.6122 |
| 23 | 155.907 | 0.85 | | | |
| 24 | −162.008 | 0.75 | 2.00100 | 29.1 | 0.5997 |
| 25 | 75.754 | (Variable) | | | |
| 26 | 237.745 | 0.70 | 1.83481 | 42.7 | 0.5648 |
| 27 | 21.842 | 4.70 | 1.78880 | 28.4 | 0.6009 |
| 28 | −276.925 | 1.68 | | | |
| 29 | −34.440 | 0.70 | 1.90525 | 35.0 | 0.5848 |
| 30 | −2223.598 | (Variable) | | | |
| 31 (SP) | ∞ | 1.76 | | | |
| 32* | 64.668 | 3.11 | 1.51633 | 64.1 | 0.5353 |
| 33 | 201.593 | 0.15 | | | |
| 34 | 66.383 | 8.49 | 1.67270 | 32.1 | 0.5988 |
| 35 | −28.560 | 1.10 | 1.95375 | 32.3 | 0.5905 |
| 36 | −63.549 | (Variable) | | | |
| 37 | 106.501 | 1.00 | 1.96300 | 24.1 | 0.6212 |
| 38 | 32.885 | 7.88 | 1.60311 | 60.6 | 0.5415 |
| 39 | −92.006 | 41.07 | | | |
| 40 | 79.111 | 7.16 | 1.53775 | 74.7 | 0.5392 |
| 41 | −55.643 | 6.54 | | | |
| 42 | −60.915 | 1.64 | 2.00100 | 29.1 | 0.5997 |
| 43 | 57.556 | 6.95 | 1.94594 | 18.0 | 0.6546 |
| 44 | −61.444 | 0.20 | | | |
| 45 | 58.796 | 8.73 | 1.53775 | 74.7 | 0.5392 |
| 46 | −34.193 | 1.00 | 2.05090 | 26.9 | 0.6054 |
| 47 | 47.594 | 0.53 | | | |
| 48 | 33.356 | 10.88 | 1.54072 | 47.2 | 0.5651 |
| 49 | −31.594 | 1.00 | 2.00100 | 29.1 | 0.5997 |
| 50 | −56.779 | 38.29 | | | |
| Image Plane | ∞ | | | | |

ASPHERIC DATA
1st Surface
k = 0.00000e+00 A 4 = −8.66041e−06 A 6 = −6.51655e−07 A 8 = −2.13941e−09
A10 = −3.92690e−13 A12 = 1.34862e−16 A14 = 6.76009e−20 A16 = 2.05226e−23
A 3 = 4.01043e−05 A 5 = 4.78919e−06 A 7 = 4.85706e−08 A 9 = 5.13358e−11
A11 = −8.34995e−15 A13 = 3.79478e−20 A15 = −2.37657e−21
3rd Surface
k = 0.00000e+00 A 4 = 6.15220e−06 A 6 = 8.47337e−07 A 8 = 1.08176e−08
A10 = −1.02156e−13 A12 = −5.86602e−14 A14 = 1.07347e−16 A16 = 3.14158e−20
A 3 = −1.82492e−05 A 5 = −3.89485e−06 A 7 = −1.19578e−07 A 9 = −5.16831e−10
A11 = 1.40336e−12 A13 = −5.08636e−16 A15 = −3.14852e−18
10th Surface
k = 0.00000e+00 A 4 = −1.09260e−06 A 6 = −1.32333e−07 A 8 = −6.91664e−10
A10 = 6.26800e−13 A12 = −6.89914e−16 A14 = −2.44905e−18 A16 = −1.79115e−22
A 3 = 3.22437e−06 A 5 = 7.63325e−07 A 7 = 1.30238e−08 A 9 = 1.19548e−11
A11 = −2.86604e−14 A13 = 8.03265e−17 A15 = 3.38170e−20
32nd Surface
k = 0.00000e+00 A 4 = −1.45679e−05 A 6 = −1.56223e−06 A 8 = −8.55794e−09
A10 = 9.91117e−11 A12 = −6.35232e−13 A14 = 3.63413e−15 A16 = 3.13580e−18
A 3 = 7.65323e−06 A 5 = 5.93543e−06 A 7 = 2.06254e−07 A 9 = −9.57453e−10
A11 = 3.01944e−12 A13 = −3.79287e−15 A15 = −1.89086e−16

VARIOUS DATA
ZOOM RATIO 4.81

| | WIDE | MIDDLE | TELE |
|---|---|---|---|
| Focal Length | 11.44 | 28.36 | 55.01 |
| Fno | 2.72 | 2.72 | 3.64 |
| Half Angle of View (°) | 52.30 | 27.56 | 15.06 |
| Image Height | 14.80 | 14.80 | 14.80 |
| Overall Lens Length | 316.37 | 316.37 | 316.37 |
| BF | 38.29 | 38.29 | 38.29 |
| d18 | 1.00 | 31.61 | 44.72 |
| d25 | 19.51 | 2.78 | 3.15 |
| d30 | 13.79 | 11.32 | 2.13 |
| d36 | 17.25 | 5.84 | 1.54 |

LENS UNIT DATA

| Lens Unit | Starting Surface | Focal Length |
|---|---|---|
| 1 | 1 | 27.04 |
| 2 | 19 | −30.72 |
| 3 | 26 | −46.91 |
| 4 | 31 | 49.89 |
| 5 | 37 | 80.52 |

### Numerical Example 4

UNIT: mm
SURFACE DATA

| Surface No. | r | d | nd | νd | θgF |
|---|---|---|---|---|---|
| 1* | 5299.568 | 2.10 | 1.83481 | 42.7 | 0.5648 |
| 2 | 26.390 | 14.36 | | | |
| 3* | 58.658 | 1.50 | 1.80400 | 46.5 | 0.5577 |
| 4 | 34.583 | 17.21 | | | |
| 5 | −47.401 | 1.40 | 1.91650 | 31.6 | 0.5911 |
| 6 | −151.774 | 0.13 | | | |
| 7 | 185.556 | 9.07 | 1.80810 | 22.8 | 0.6307 |
| 8 | −77.219 | 1.20 | | | |
| 9 | −736.255 | 7.89 | 1.59522 | 67.7 | 0.5442 |
| 10* | −65.163 | 3.98 | | | |
| 11 | 272.869 | 14.19 | 1.49700 | 81.5 | 0.5375 |
| 12 | −41.172 | 1.70 | 1.95375 | 32.3 | 0.5905 |
| 13 | −66.501 | 0.21 | | | |
| 14 | 229.770 | 1.70 | 2.00100 | 29.1 | 0.5997 |
| 15 | 52.199 | 16.99 | 1.53775 | 74.7 | 0.5392 |
| 16 | −66.894 | 0.20 | | | |
| 17 | 1475.240 | 5.58 | 1.65412 | 39.7 | 0.5737 |
| 18 | −86.882 | (Variable) | | | |
| 19* | 64.766 | 0.93 | 1.85150 | 40.8 | 0.5695 |
| 20 | 29.448 | 3.62 | | | |
| 21 | 378.242 | 0.85 | 1.76385 | 48.5 | 0.5589 |
| 22 | 18.644 | 5.33 | 1.85478 | 24.8 | 0.6122 |
| 23 | 192.908 | 0.72 | | | |
| 24 | −203.604 | 0.75 | 2.00100 | 29.1 | 0.5997 |
| 25 | 67.794 | (Variable) | | | |
| 26 | 195.242 | 0.70 | 1.83481 | 42.7 | 0.5648 |
| 27 | 20.129 | 4.88 | 1.78880 | 28.4 | 0.6009 |
| 28 | −237.204 | 1.74 | | | |
| 29 | −31.449 | 0.70 | 1.90525 | 35.0 | 0.5848 |
| 30* | −421.412 | (Variable) | | | |
| 31 (SP) | ∞ | 1.23 | | | |
| 32* | 163.720 | 2.99 | 1.51633 | 64.1 | 0.5353 |
| 33 | −202.442 | 0.15 | | | |
| 34 | 57.211 | 8.44 | 1.67270 | 32.1 | 0.5988 |
| 35 | −37.304 | 1.10 | 1.95375 | 32.3 | 0.5905 |
| 36 | −91.416 | (Variable) | | | |
| 37 | 116.199 | 1.00 | 1.96300 | 24.1 | 0.6212 |
| 38 | 32.690 | 10.95 | 1.60311 | 60.6 | 0.5415 |
| 39 | −87.682 | 41.08 | | | |
| 40 | 60.246 | 7.67 | 1.53775 | 74.7 | 0.5392 |
| 41 | −59.558 | 5.50 | | | |
| 42 | −65.204 | 1.00 | 1.95375 | 32.3 | 0.5905 |
| 43 | 48.375 | 6.55 | 1.92286 | 18.9 | 0.6495 |
| 44 | −76.368 | 1.96 | | | |
| 45 | 54.589 | 7.71 | 1.53775 | 74.7 | 0.5392 |
| 46 | −38.732 | 1.00 | 2.00100 | 29.1 | 0.5997 |
| 47 | 36.562 | 0.21 | | | |
| 48 | 29.834 | 14.04 | 1.51823 | 58.9 | 0.5457 |
| 49 | −26.006 | 1.00 | 2.00100 | 29.1 | 0.5997 |
| 50 | −45.952 | 37.99 | | | |
| Image Plane | ∞ | | | | |

ASPHERIC DATA
1st Surface
k = 0.00000e+00 A 4 = −3.00133e−06 A 6 = −4.71204e−07 A 8 = −1.57470e−09
A10 = −3.13880e−13 A12 = 6.91900e−17 A14 = −1.65891e−19 A16 = −9.75519e−24
A 3 = 2.05042e−05 A 5 = 3.37014e−06 A 7 = 3.53575e−08 A 9 = 3.87228e−11
A11 = −6.62646e−15 A13 = 5.37587e−18 A15 = 2.00120e−21
3rd Surface
k = 0.00000e+00 A 4 = 5.38076e−06 A 6 = 8.40880e−07 A 8 = 1.06309e−08
A10 = −8.81100e−13 A12 = −6.65923e−14 A14 = 7.99567e−17 A16 = 2.61196e−20
A 3 = −1.21314e−05 A 5 = −3.79326e−06 A 7 = −1.18698e−07 A 9 = −4.99386e−10
A11 = 1.45840e−12 A13 = 1.37723e−16 A15 = −2.55421e−18
10th Surface
k = 0.00000e+00 A 4 = 5.55314e−07 A 6 = −3.22665e−08 A 8 = 7.86250e−11
A10 = 1.00039e−12 A12 = −1.68194e−16 A14 = −2.74405e−19 A16 = 4.69241e−23
A 3 = 1.19903e−06 A 5 = 2.29863e−07 A 7 = 1.72919e−09 A 9 = −1.70004e−11
A11 = −2.31999e−14 A13 = 1.92733e−17 A15 = −1.60775e−21
19th Surface
k = 0.00000e+00 A 4 = 1.18567e−07 A 6 = 1.22085e−09 A 8 = −1.22302e−11
A10 = 8.72663e−17 A12 = −3.01996e−19 A14 = 6.91730e−22 A16 = 3.09204e−24
A 3 = −2.28028e−07 A 5 = −1.85118e−08 A 7 = 4.56647e−11 A 9 = 5.04436e−13
A11 = 2.05552e−18 A13 = −8.72532e−21 A15 = −3.99022e−23
30th Surface
k = 0.00000e+00 A 4 = −7.03741e−08 A 6 = 4.14639e−11 A 8 = 1.27259e−13
A10 = 5.56621e−15 A12 = 1.73647e−17 A14 = −2.88252e−19 A16 = −2.69879e−21
A 3 = 3.00352e−07 A 5 = −7.77383e−10 A 7 = 6.65859e−13 A 9 = −6.10018e−14
A11 = 3.09287e−18 A13 = −2.52017e−18 A15 = 5.64637e−20
32nd Surface
k = 0.00000e+00 A 4 = 6.97696e−06 A 6 = −7.89453e−07 A 8 = −1.98584e−08
A10 = −9.04060e−11 A12 = −3.46036e−13 A14 = −1.55281e−15 A16 = −4.73404e−19
A 3 = 2.08347e−06 A 5 = 2.49198e−06 A 7 = 1.55372e−07 A 9 = 1.65304e−09
A11 = 4.31418e−12 A13 = 2.96113e−14 A15 = 4.25677e−17

VARIOUS DATA
ZOOM RATIO 4.81

| | WIDE | MIDDLE | TELE |
|---|---|---|---|
| Focal Length | 11.44 | 28.23 | 55.01 |
| Fno | 2.77 | 2.78 | 3.62 |
| Half Angle of View (°) | 52.30 | 27.67 | 15.06 |
| Image Height | 14.80 | 14.80 | 14.80 |
| Overall Lens Length | 320.42 | 320.42 | 320.42 |
| BF | 37.99 | 37.99 | 37.99 |
| d18 | 1.30 | 29.65 | 41.79 |
| d25 | 18.08 | 2.75 | 3.29 |
| d30 | 14.60 | 12.08 | 2.75 |
| d36 | 15.24 | 4.75 | 1.38 |

LENS UNIT DATA

| Lens Unit | Starting Surface | Focal Length |
|---|---|---|
| 1 | 1 | 25.62 |
| 2 | 19 | −28.87 |
| 3 | 26 | −47.87 |
| 4 | 31 | 50.19 |
| 5 | 37 | 79.50 |

### Numerical Example 5

UNIT: mm
SURFACE DATA

| Surface No. | r | d | nd | νd | θgF |
|---|---|---|---|---|---|
| 1* | 10000.000 | 2.20 | 1.83481 | 42.7 | 0.5648 |
| 2 | 27.261 | 10.90 | | | |
| 3* | 43.746 | 1.55 | 1.85150 | 40.8 | 0.5695 |
| 4 | 29.780 | 16.94 | | | |
| 5 | −54.008 | 1.45 | 1.95375 | 32.3 | 0.5905 |
| 6 | 2340.232 | 0.20 | | | |
| 7 | 126.680 | 7.91 | 1.80810 | 22.8 | 0.6307 |
| 8 | −96.980 | 1.49 | | | |
| 9 | 337.211 | 8.36 | 1.59522 | 67.7 | 0.5442 |
| 10* | −58.106 | 2.89 | | | |
| 11 | 311.073 | 13.21 | 1.43875 | 94.7 | 0.5340 |
| 12 | −37.563 | 1.60 | 1.95375 | 32.3 | 0.5905 |
| 13 | −52.130 | 0.20 | | | |
| 14 | 195.594 | 1.60 | 2.00100 | 29.1 | 0.5997 |
| 15 | 53.751 | 14.24 | 1.43875 | 94.7 | 0.5340 |
| 16 | −56.590 | 0.20 | | | |
| 17 | −307.119 | 4.72 | 1.76634 | 35.8 | 0.5792 |
| 18 | −68.430 | (Variable) | | | |
| 19 | 67.923 | 0.95 | 1.80400 | 46.5 | 0.5577 |
| 20 | 32.553 | 2.99 | | | |
| 21 | −4920.510 | 0.85 | 1.76385 | 48.5 | 0.5589 |
| 22 | 22.528 | 5.55 | 1.78880 | 28.4 | 0.6009 |
| 23 | −75.906 | (Variable) | | | |
| 24 | −70.205 | 0.75 | 1.88300 | 40.8 | 0.5667 |
| 25 | 50.820 | (Variable) | | | |
| 26 | −32.470 | 0.70 | 1.80400 | 46.5 | 0.5577 |
| 27 | 29.951 | 2.65 | 1.78880 | 28.4 | 0.6009 |
| 28 | 433.737 | (Variable) | | | |
| 29 (SP) | ∞ | 2.04 | | | |
| 30 | −8622.845 | 1.00 | 1.83481 | 42.7 | 0.5648 |
| 31 | 54.401 | 3.85 | 1.67300 | 38.3 | 0.5757 |
| 32 | −599.694 | 0.20 | | | |
| 33* | 36.239 | 7.96 | 1.57501 | 41.5 | 0.5767 |
| 34 | −138.526 | (Variable) | | | |
| 35 | 263.730 | 2.31 | 1.48749 | 70.2 | 0.5300 |
| 36 | −187.158 | 0.20 | | | |
| 37 | 72.439 | 1.20 | 2.00069 | 25.5 | 0.6136 |
| 38 | 32.243 | 8.37 | 1.51823 | 58.9 | 0.5457 |
| 39 | −113.669 | 41.34 | | | |
| 40 | 74.294 | 7.17 | 1.49700 | 81.5 | 0.5375 |
| 41 | −55.213 | 0.72 | | | |
| 42 | −216.396 | 1.20 | 2.00100 | 29.1 | 0.5997 |
| 43 | 25.638 | 9.15 | 1.89286 | 20.4 | 0.6393 |
| 44 | −2098.664 | 0.20 | | | |
| 45 | 29.296 | 8.30 | 1.67300 | 38.3 | 0.5757 |
| 46 | −108.576 | 1.58 | 2.00100 | 29.1 | 0.5997 |
| 47 | 24.135 | 0.20 | | | |
| 48 | 21.983 | 14.17 | 1.43875 | 94.7 | 0.5340 |
| 49 | −24.253 | 1.00 | 2.00100 | 29.1 | 0.5997 |
| 50 | −52.485 | 39.12 | | | |
| Image Plane | ∞ | | | | |

ASPHERIC DATA
1st Surface
k = 0.00000e+00 A 4 = −4.39106e−05 A 6 = −1.26499e−06 A 8 = −3.62054e−09
A10 = −6.42274e−13 A12 = 3.92028e−16 A14 = 6.61559e−20 A16 = 7.34553e−24
A 3 = 1.49036e−04 A 5 = 1.08520e−05 A 7 = 8.69501e−08 A 9 = 8.38675e−11
A11 = −1.50177e−14 A13 = −3.97045e−18 A15 = −1.20551e−21
3rd Surface
k = 0.00000e+00 A 4 = 2.70307e−05 A 6 = 9.13168e−07 A 8 = 9.74093e−09
A10 = 2.53181e−11 A12 = −1.22397e−14 A14 = 7.66186e−17 A16 = 2.34551e−20
A 3 = −9.70765e−05 A 5 = −6.69142e−06 A 7 = −1.01727e−07 A 9 = −6.68975e−10
A11 = −1.89298e−13 A13 = −6.65266e−16 A15 = −2.28044e−18
10th Surface
k = 0.00000e+00 A 4 = 3.66220e−06 A 6 = 4.66240e−09 A 8 = 4.98196e−13
A 3 = −5.18478e−06 A 5 = −9.23355e−08 A 7 = −9.72622e−11
33rd Surface
k = 0.00000e+00 A 4 = −7.27259e−06 A 6 = 2.24551e−09 A 8 = −2.15475e−12

VARIOUS DATA
ZOOM RATIO 4.81

| | WIDE | MIDDLE | TELE |
|---|---|---|---|
| Focal Length | 11.44 | 28.81 | 55.02 |
| Fno | 2.72 | 2.72 | 3.64 |
| Half Angle of View (°) | 52.30 | 27.19 | 15.06 |
| Image Height | 14.80 | 14.80 | 14.80 |
| Overall Lens Length | 307.39 | 307.39 | 307.39 |
| BF | 39.12 | 39.12 | 39.12 |
| d18 | 0.98 | 27.50 | 38.86 |
| d23 | 1.00 | 2.87 | 4.26 |
| d25 | 23.60 | 4.18 | 4.43 |
| d28 | 11.96 | 10.23 | 2.97 |
| d34 | 14.47 | 7.22 | 1.48 |

LENS UNIT DATA

| Lens Unit | Starting Surface | Focal Length |
|---|---|---|
| 1 | 1 | 26.71 |
| 2 | 19 | −1804.98 |
| 3 | 24 | −33.29 |
| 4 | 26 | −36.79 |
| 5 | 29 | 55.77 |
| 6 | 35 | 70.65 |

### Numerical Example 6

UNIT: mm
SURFACE DATA

| Surface No. | r | d | nd | νd | θgF |
|---|---|---|---|---|---|
| 1* | −593.245 | 2.80 | 1.80100 | 35.0 | 0.5864 |
| 2 | 40.556 | 23.76 | | | |
| 3 | −134.047 | 2.00 | 1.64000 | 60.1 | 0.5370 |
| 4 | 131.169 | 0.19 | | | |
| 5 | 106.867 | 6.84 | 1.95906 | 17.5 | 0.6598 |
| 6 | 1000.817 | 1.20 | | | |
| 7 | 212.154 | 10.59 | 1.59522 | 67.7 | 0.5442 |
| 8* | −93.369 | 4.89 | | | |
| 9 | 267.370 | 5.59 | 1.43875 | 94.7 | 0.5340 |
| 10 | −263.318 | 2.00 | 1.84666 | 23.8 | 0.6205 |
| 11 | 2059.769 | 0.20 | | | |
| 12 | 179.486 | 5.49 | 1.49700 | 81.5 | 0.5375 |
| 13 | −461.401 | 0.20 | | | |
| 14 | 200.496 | 2.00 | 1.80518 | 25.4 | 0.6161 |
| 15 | 52.168 | 16.62 | 1.43875 | 94.7 | 0.5340 |
| 16 | −116.675 | 0.20 | | | |
| 17 | 98.109 | 11.35 | 1.76385 | 48.5 | 0.5589 |
| 18 | −124.523 | (Variable) | | | |
| 19* | −245.470 | 1.24 | 2.05090 | 26.9 | 0.6054 |
| 20 | 23.985 | 7.28 | | | |
| 21 | −24.539 | 0.85 | 1.49700 | 81.5 | 0.5375 |
| 22 | 52.504 | 6.17 | 1.85478 | 24.8 | 0.6122 |
| 23 | −25.337 | 0.77 | | | |
| 24 | −22.134 | 1.00 | 1.88300 | 40.8 | 0.5667 |
| 25 | −43.940 | (Variable) | | | |
| 26 | −30.558 | 0.80 | 1.59522 | 67.7 | 0.5442 |
| 27 | 43.554 | 2.98 | 1.85896 | 22.7 | 0.6284 |
| 28 | 120.762 | (Variable) | | | |
| 29 (SP) | ∞ | 0.20 | | | |
| 30* | 46.471 | 6.93 | 1.89190 | 37.1 | 0.5780 |
| 31 | −171.374 | 1.50 | | | |
| 32 | −261.856 | 1.10 | 2.00069 | 25.5 | 0.6136 |
| 33 | 47.598 | 8.01 | 1.55200 | 70.7 | 0.5421 |
| 34 | −99.980 | (Variable) | | | |
| 35 | 190.724 | 7.97 | 1.48749 | 70.2 | 0.5300 |
| 36 | −45.827 | 0.25 | | | |
| 37 | −175.785 | 10.09 | 1.76182 | 26.5 | 0.6136 |
| 38 | −27.149 | 1.10 | 2.00100 | 29.1 | 0.5997 |
| 39 | −114.183 | 45.79 | | | |
| 40 | 124.021 | 8.14 | 1.48749 | 70.2 | 0.5300 |
| 41 | −46.522 | 2.04 | | | |
| 42 | 52.765 | 9.56 | 1.80810 | 22.8 | 0.6307 |
| 43 | −34.718 | 0.90 | 2.00100 | 29.1 | 0.5997 |
| 44 | 32.195 | 1.30 | | | |
| 45 | 28.555 | 11.51 | 1.43875 | 94.7 | 0.5340 |
| 46 | −29.213 | 1.00 | 1.88300 | 40.8 | 0.5667 |
| 47 | 84.000 | 0.49 | | | |
| 48 | 40.695 | 11.64 | 1.48749 | 70.2 | 0.5300 |
| 49 | −23.798 | 2.00 | 2.00100 | 29.1 | 0.5997 |
| 50 | −32.954 | 49.42 | | | |
| Image Plane | ∞ | | | | |

ASPHERIC DATA
1st Surface
K = 0.00000e+00 A 4 = 1.27215e−06 A 6 = 8.56311e−11 A 8 = −2.31014e−13
A10 = 2.89318e−17 A12 = 6.96656e−20 A14 = −3.96549e−23 A16 = 6.65814e−27
8th Surface
K = 0.00000e+00 A 4 = 9.46906e−07 A 6 = 1.42931e−10 A 8 = −3.43431e−13
A10 = 6.49235e−16 A12 = −7.53367e−19 A14 = 4.15262e−22 A16 = −8.81887e−26
19th Surface
K = 0.00000e+00 A 4 = 9.53190e−06 A 6 = −8.97502e−09 A 8 = −4.34509e−11
A10 = 3.58906e−13 A12 = −4.99424e−16
30th Surface
K = 0.00000e+00 A 4 = −4.13215e−06 A 6 = 2.87944e−09 A 8 = −1.91722e−12

VARIOUS DATA
ZOOM RATIO 6.92

| | WIDE | MIDDLE | TELE |
|---|---|---|---|
| Focal Length | 14.44 | 53.52 | 100.00 |
| Fno | 2.73 | 2.73 | 3.21 |
| Half Angle of View (°) | 45.70 | 15.46 | 8.42 |
| Image Height | 14.80 | 14.80 | 14.80 |
| Overall Lens Length | 350.17 | 350.17 | 350.17 |
| BF | 49.42 | 49.42 | 49.42 |
| d18 | 0.98 | 34.03 | 42.29 |
| d25 | 29.14 | 2.36 | 2.97 |
| d28 | 8.77 | 8.39 | 0.99 |
| d34 | 13.33 | 7.45 | 5.97 |

LENS UNIT DATA

| Lens Unit | Starting Surface | Focal Length |
|---|---|---|
| 1 | 1 | 37.39 |
| 2 | 19 | −23.29 |
| 3 | 26 | −48.31 |
| 4 | 29 | 59.45 |
| 5 | 35 | 75.10 |

Table I summarizes values of inequalities (1) to (8) in numerical examples 1 to 6. The zoom lens according to each numerical example satisfy all of inequalities (1) to (8).

| | | | Numerical Example | | | | | |
|---|---|---|---|---|---|---|---|---|
| | | | 1 | 2 | 3 | 4 | 5 | 6 |
| Inequality | (1) | LS/fw | 14.05 | 15.20 | 14.40 | 14.58 | 14.49 | 13.45 |
| | (2) | fw/LP | −0.060 | −0.062 | −0.039 | −0.042 | −0.067 | −0.024 |
| | (3) | LE/LR | 0.433 | 0.400 | 0.434 | 0.412 | 0.426 | 0.402 |
| | (4) | fRR/fR | 1.521 | 1.751 | 1.359 | 1.335 | 1.982 | 1.520 |
| | (5) | fFR/fR | 2.419 | 2.124 | 2.662 | 2.978 | 1.804 | 1.523 |
| | (6) | NR | 1.795 | 1.790 | 1.802 | 1.782 | 1.786 | 1.730 |
| | (7) | f1/fw | 2.359 | 2.287 | 2.355 | 2.231 | 2.327 | 2.589 |
| | (8) | f1/f2 | −0.923 | −0.856 | −0.878 | −0.885 | −0.875 | −1.605 |
| | | fw | 11.44 | 11.44 | 11.44 | 11.44 | 11.44 | 14.44 |
| | | LS | 160.74 | 173.89 | 164.72 | 166.82 | 165.76 | 194.26 |
| | | LP | −189.52 | −185.00 | −292.37 | −269.41 | −171.61 | −603.51 |
| | | LE | 41.03 | 41.34 | 41.07 | 41.08 | 41.34 | 45.79 |
| | | LR | 94.68 | 103.40 | 94.57 | 99.67 | 97.12 | 113.77 |
| | | fR | 81.39 | 75.46 | 80.98 | 79.94 | 70.94 | 75.10 |
| | | fFR | 196.89 | 160.26 | 215.58 | 238.07 | 127.99 | 114.36 |
| | | fRR | 123.78 | 132.13 | 110.07 | 106.76 | 140.63 | 114.18 |
| | | f1 | 26.99 | 26.16 | 26.94 | 25.53 | 26.62 | 37.39 |
| | | f2 | −29.24 | −30.54 | −30.68 | −28.83 | −30.42 | −23.29 |

### Image Pickup Apparatus

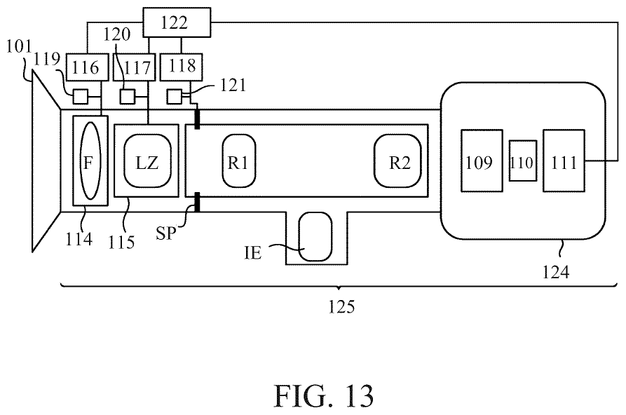

FIG. 13 illustrates an image pickup apparatus including any one of the zoom lenses according to Examples 1 to 6 as an imaging optical system. In FIG. 13, reference numeral 101 denotes one of the zoom lenses according to Examples 1 to 6. Reference numeral 124 denotes a camera body. Reference numeral 125 denotes an image pickup apparatus configured by mounting the zoom lens 101 to the camera body 124. The zoom lens 101 is attachable to and detachable from the camera body 124. However, the zoom lens 101 may be integrated with the camera body 124.

The zoom lens 101 includes, in order from the object side to the image side, a first lens unit F, a zoom unit LZ, and an imaging lens unit R. The first lens unit F includes a focus sub-lens unit that moves during focusing. The zoom unit LZ is the intermediate group including at least three or more lens units. An aperture stop SP, a lens unit R1, and a lens unit R2 are disposed on the image side of the zoom unit LZ. The image pickup apparatus 125 further includes an optical unit IE that can be inserted into and removed from the optical path between the lens units R1 and R2. Inserting the optical unit IE into space between the lens units R1 and R2 can change the focal length range of the zoom lens 101.

Reference numerals 114 and 115 denote drive mechanisms configured to move the first lens unit F and the lens units included in the zoom unit LZ along the optical axis. Reference numerals 116 to 118 denote motors configured to drive the drive mechanisms 114 and 115 and the aperture stop SP, respectively. Reference numeral 119 to 121 denote detectors configured to detect the position of the first lens unit F on the optical axis and the position of the lens units included in the zoom unit LZ, and detect the aperture diameter of the aperture stop SP, respectively.

In the camera body 124, reference numeral 109 denotes a glass block such as an optical filter, and reference numeral 110 denotes an image sensor configured to capture an object image formed by the zoom lens 101 (i.e., image the object through the zoom lens 101). The image sensor 110 includes a photoelectric conversion element such as a CCD sensor, a CMOS sensor, etc. Reference numerals 111 and 122 denote a camera CPU serving as a processing unit in the camera body 124 and a lens CPU serving as a processing unit in the zoom lens 101, respectively.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide a zoom lens that has a reduced size, a wide angle of view. In addition, each example according to the disclosure can provide a zoom lens that has good optical performance.

This application claims the benefit of Japanese Patent Application No. 2024-191079, which was filed on Oct. 30, 2024, and which is hereby incorporated by reference herein in its entirety.

What is claimed is:

1. A zoom lens comprising:
a plurality of lens units,
wherein the plurality of lens units include, in order from an object side to an image side,
a first lens unit with positive refractive power that does not move for zooming,
an intermediate group including at least three movable lens units that move for zooming, and
a rear lens unit with positive refractive power that does not move for zooming,
wherein each distance between adjacent lens units changes during zooming,
wherein the first lens unit includes a focus sub-lens unit that moves for focusing,
wherein one of the at least three movable lens units in the intermediate group includes an aperture stop, and
wherein the following inequalities are satisfied:
$$12 \leq LS / fw \leq 40$$
$$- 0.15 \leq fw / LP \leq - 0.01$$
where LS is a distance on an optical axis from the aperture stop to an image plane at a wide-angle end, fw is a focal length of the zoom lens at the wide-angle end, LP is a distance on the optical axis from the image plane to an exit pupil of the zoom lens at the wide-angle end, and a direction from the image plane toward the object side is negative.

2. The zoom lens according to claim 1, wherein the rear lens unit includes a front sub-lens unit and a rear sub-lens unit arranged in order from the object side to the image side via a widest distance in the rear lens unit, and
wherein the following inequality is satisfied:
$$0.35 \leq LE / LR \leq 0.6$$
where LE is the widest distance, and LR is a distance on the optical axis from a surface closest to an object of the rear lens unit to a surface closest to the image plane of the rear lens unit.

3. The zoom lens according to claim 2, wherein the following inequality is satisfied:
$$0.9 \leq fRR / fR \leq 2.4$$
where fR is a focal length of the rear lens unit, and fRR is a focal length of the rear sub-lens unit.

4. The zoom lens according to claim 2, wherein the following inequality is satisfied:
$$1. \leq fFR / fR \leq 3.4$$
where fR is a focal length of the rear lens unit, and fFR is a focal length of the front sub-lens unit.

5. The zoom lens according to claim 2, wherein the following inequality is satisfied:
$$1.7 \leq NR \leq 2.$$
where NR is an average value of a refractive index for d-line of all lenses included in the rear sub-lens unit.

6. The zoom lens according to claim 1, wherein the following inequality is satisfied:
$$1. \leq f 1 / fw \leq 10.$$
where f1 is a focal length of the first lens unit.

7. The zoom lens according to claim 1, wherein the intermediate group includes a variator unit with negative refractive power as a whole including one or two movable lens units, and
wherein the following inequality is satisfied:
$$- 6. \leq f 1 / f 2 < 0.$$
where f1 is a focal length of the first lens unit, and f2 is a focal length of the variator unit.

8. The zoom lens according to claim 1, wherein the first lens unit includes:
a first sub-lens unit with negative refractive power that is disposed closer to an object than the focus sub-lens unit and does not move for focusing,
a second sub-lens unit with positive refractive power as the focus sub-lens unit, and
a third sub-lens unit with positive refractive power that is disposed closer to the image than the focus sub-lens unit and does not move for focusing.

9. The zoom lens according to claim 2, wherein a lens disposed closest to the image plane of the rear sub-lens unit has negative refractive power.

10. The zoom lens according to claim 2, wherein the rear sub-lens unit includes seven or more lenses.

11. The zoom lens according to claim 1, wherein the plurality of lens units include, in order from the object side to the image side,
the first lens unit,
a second lens unit with negative refractive power, a third lens unit with negative refractive power, and a fourth lens unit with positive refractive power including the aperture stop, which are the at least three movable lens units in the intermediate group, and
a fifth lens unit as the rear lens unit.

12. The zoom lens according to claim 1, wherein the plurality of lens units include, in order from the object side to the image side,
the first lens unit,
a second lens unit with negative refractive power, a third lens unit with negative refractive power, a fourth lens unit with negative refractive power, and a fifth lens unit with positive refractive power including the aperture stop, which are the at least three movable lens units in the intermediate group, and
a sixth lens unit as the rear lens unit.

13. A zoom lens comprising:
a plurality of lens units,
wherein the plurality of lens units include, in order from an object side to an image side,
a first lens unit with positive refractive power that does not move for zooming,
an intermediate group including at least three movable lens units that move for zooming, and
a rear lens unit with positive refractive power that does not move for zooming,
wherein each distance between adjacent lens units changes during zooming,
wherein the first lens unit includes a focus sub-lens unit that moves for focusing,
wherein one of the at least three movable lens units in the intermediate group includes an aperture stop, and
wherein the following inequality is satisfied:
$$12 \leq LS / fw \leq 40$$
where LS is a distance on an optical axis from the aperture stop to an image plane at a wide-angle end, fw is a focal length of the zoom lens at the wide-angle end.

14. An image pickup apparatus comprising:
a zoom lens; and
an image sensor configured to image an object through the zoom lens,
wherein the zoom lens includes a plurality of lens units,
wherein the plurality of lens units include, in order from an object side to an image side,
a first lens unit with positive refractive power that does not move for zooming,
an intermediate group including at least three movable lens units that move for zooming, and
a rear lens unit with positive refractive power that does not move for zooming,
wherein each distance between adjacent lens units changes during zooming,
wherein the first lens unit includes a focus sub-lens unit that moves for focusing,
wherein one of the at least three movable lens units in the intermediate group includes an aperture stop, and
wherein the following inequalities are satisfied:
$$12 \leq LS / fw \leq 40$$
$$- 0.15 \leq fw / LP \leq - 0.01$$
where LS is a distance on an optical axis from the aperture stop to an image plane at a wide-angle end, fw is a focal length of the zoom lens at the wide-angle end, LP is a distance on the optical axis from the image plane to an exit pupil of the zoom lens at the wide-angle end, and a direction from the image plane toward the object side is negative.
